(19) United States
(12) Patent Application Publication
(10) Pub. No.: US 2018/0314598 A1
(43) Pub. Date: Nov. 1, 2018

(54) CONTAINER-BASED BACKUPS

(71) Applicant: Hewlett Packard Enterprise Development LP, Houston, TX (US)

(72) Inventors: Mandar Nanivadekar, Bangalore (IN); Shishir Misra, Bangalore (IN); Gautam Bhasin, Bangalore (IN)

(21) Appl. No.: 15/581,825

(22) Filed: Apr. 28, 2017

(51) Int. Cl. G06F 11/14; G06F 17/30; G06F 9/455

(52) U.S. Cl. CPC G06F 11/1451; G06F 11/1464; G06F 2201/80; G06F 17/30292; G06F 9/45504; G06F 11/1469

(57) ABSTRACT

Examples disclosed herein relate to container-based backups. Some of the examples may enable analyzing a source host to be backed up, wherein the source host is not a container instance, and determining a portion of the source host for which a container representation is to be created. The container representation may comprise a source host image that is captured at the time of backup. Some of the examples may enable creating the container representation.

### BACKGROUND

Containerization has gained popularity in recent years. Containerization is a mechanism to wrap a software application and its dependencies into a package (referred to herein as a “container”), allowing the software application to run in isolation. This means that a server could be running many containers where the containers themselves are not aware of existence of other containers.

### BRIEF DESCRIPTION OF THE DRAWINGS

The following detailed description references the drawings, wherein:

FIG. 1 is a block diagram depicting an example container-based backup system comprising various components including a container host and source hosts for enabling a container-based backup.

FIG. 2 is a block diagram depicting an example container-based backup system.

FIG. 3 is a block diagram depicting an example container-based backup system.

FIG. 4 is a block diagram depicting an example machine-readable storage medium comprising instructions executable by a processor for enabling a container-based backup.

FIG. 5 is a block diagram depicting an example machine-readable storage medium comprising instructions executable by a processor for enabling a container-based backup.

FIG. 6 is a flow diagram depicting an example method for enabling a container-based backup.

FIG. 7 is a flow diagram depicting an example method for enabling a container-based backup.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Backup and archiving applications are responsible for backing up customer data in the enterprise. These backup applications support backups of, for example, filesystem data, database, and/or virtual machines. The data may be backed up to storage targets such as tape drives, disk arrays, snapshots, common internet file system (CIFS)/network attached storage (NAS) shares, and/or deduplication appliances. The backup application stores this data in its own format. The data being backed up is split into chunks and stored with additional metadata. At the time of recovery, the data is transferred from the storage target to a recovery destination. Because the large size of enterprise data being backed up, the data recovery could take a long time. In addition, the backup data cannot be accessed to view and understand the data therein until the backup data is fully recovered.

Examples disclosed herein provide technical solutions to these technical challenges by enabling a container-based backup and recovery using containerization technologies. Containerization is a mechanism to wrap a software application and its dependencies into a package (referred to herein as a “container”), allowing the software application to run in isolation. This means that a server could be running many containers where the containers themselves are not aware of existence of other containers.

In some implementations, some of the disclosed examples may enable creating a container representation that comprises a source host image that is captured at the time of backup. This means that the container represents a snapshot of a “live” state of the source host at the time of backup. Thus, the container representation may capture a point-in-time state of: applications, their dependencies (e.g., code, runtime, and system tools and libraries), configuration data (e.g., database infrastructure configuration data, network configuration data, etc.), and/or any other data of the source host. In addition, because containerization technologies package all of the necessary data such as an application and its dependencies, and configuration data of a complete filesystem, a resulting container representation can run in any host environment (e.g., on premises, public cloud, private cloud, or bare metal). In some instances, containerization technologies can enable creating separate data and application containers for the source host. For example, a simple data container can be created without the application (e.g., operating system (OS)/kernel elements) while a complete container includes the data as well as the application. Simple data containers could be useful in the case of filesystem backups where a sub-section of target volumes gets backed up. On the other hand, for application backups, complete containers would be more appropriate.

A “source host,” may comprise a filesystem server, a database server, a virtual machine (VM) instance, a container instance, an email server, a web server, an application host server, a SharePoint farm, and/or other host types. Some of the disclosed examples may enable analyzing a source host to be backed up. For example, a backup software application agent that runs on the source host may employ different mechanisms for different source host types. The application agent may identify a backup specification to determine which portion of the source host would be backed up. For example, a file server may have multiple volumes (e.g., C:, E:, F:), but the backup specification may indicate that the volume F: is the one that is subject to a backup. In this case, a container representation would be created with that volume but not the other volumes. For a database server backup, the application agent may analyze the database infrastructure and backup the information related to the database infrastructure including database configuration data, network configuration data, etc.

In some implementations, some of the disclosed examples may enable creating a container representation of a source host where the container representation may be a full backup of at least a portion of the source host or an incremental backup of at least a portion of the source host.

In some implementations, some of the disclosed examples may enable data recovery by launching a container representation of a source host at a container host. In one example, the container representation (or any portion thereof) may be copied to a target destination for recovery at the target destination. In another example, the container representation that includes an operating system (OS) can be instantiated on its own by running any applications backed up in the container representation from the container representation itself. In both of these examples, the recovery time can be significantly shorter than using non-containerization-based backup and recovery techniques.

A “container host,” may refer to a computing device, a data storage, or a combination thereof that stores container representation files and/or launches them for data recovery. In some cases, a container host can act as an intermediate disk based target in the Disk-To-Disk-To-Tape backup strategy (e.g., where data is first transferred to disk based storage for faster transfers and then transferred to tape based storage for longer term retention) for faster and more easily manageable storage target. Container hosts can be dynamically added or reduced for scalability and load balancing.

In some implementations, a container representation may be launched and/or shut down in an instant, meaning that a user can access the data in the container very quickly without waiting for the backup data be fully recovered. In addition, an individual data item may be restored from the backup data in a container representation without having to recover the entire backup data. For example, a single email may be recovered from a container representation of an email server without having to restoring the entire email backup data from the container representation.

In some implementations, a container host may archive container representation files that are not frequently used to a secondary storage target, and, when needed, bring back a particular archived container representation file to the container host for it to be launched. In some implementations, an archived container representation may be launched from the secondary storage target by writing volume plugins.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

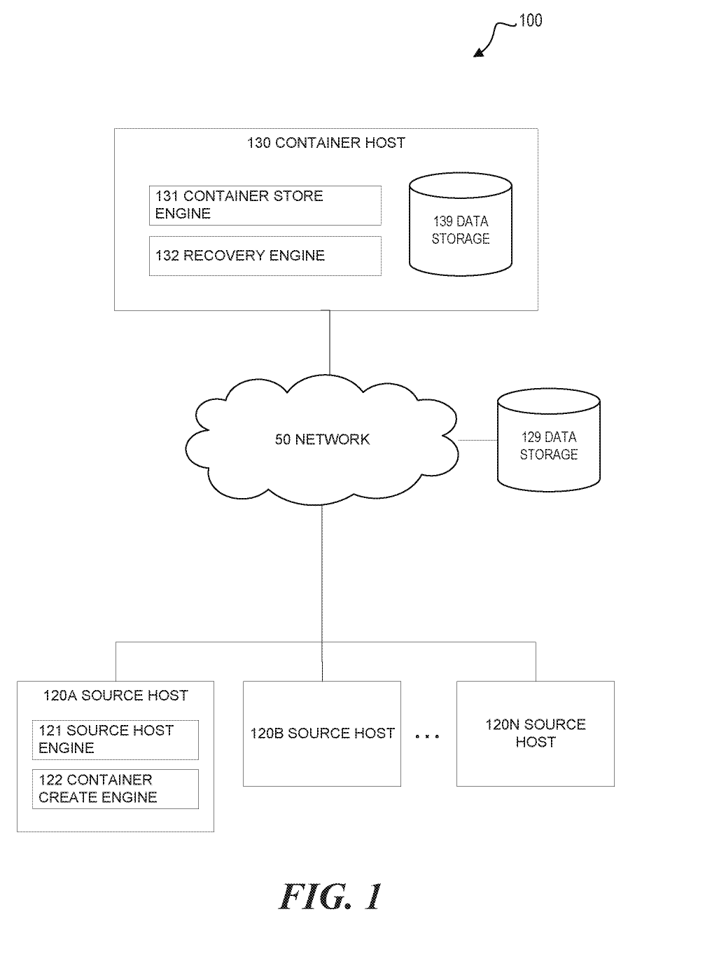

FIG. 1 is a block diagram depicting an example container-based backup system 100 comprising various components including a container host and source hosts for enabling a container-based backup.

The various components may include source hosts 120 (illustrated as 120A, 120B, . . . , 120N) and a container host 130. Although the container host 130 is depicted as a single component, a plurality of container hosts may exist in system 100. A “source host” may refer to a host device or instance for which a backup is created, and may comprise, for example, a filesystem server, a database server, a virtual machine (VM) instance, a container instance, an email server, a web server, an application host server, a SharePoint farm, and/or other host types. A “container host,” may refer to a computing device, a data storage, or a combination thereof that stores container representation files and/or launches them for data recovery. In some cases, a container host can act as an intermediate disk based target in the Disk-To-Disk-To-Tape backup strategy (e.g., where data is first transferred to disk based storage for faster transfers and then transferred to tape based storage for longer term retention) for faster and more easily manageable storage target. Container hosts can be dynamically added or reduced for scalability and load balancing. Any container representation files may be stored in a data storage associated a container host, such as a data storage 139. Although data storage 139 is depicted as a local data storage for container host 130, data storage 139 may be a remote data storage that is connected to container host 130 via network (e.g., network 50).

The various components depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, system 100 and the various components described herein may be implemented in hardware and/or programming that configures hardware. Furthermore, in FIG. 1 and other Figures described herein, different numbers of components or entities than depicted may be used.

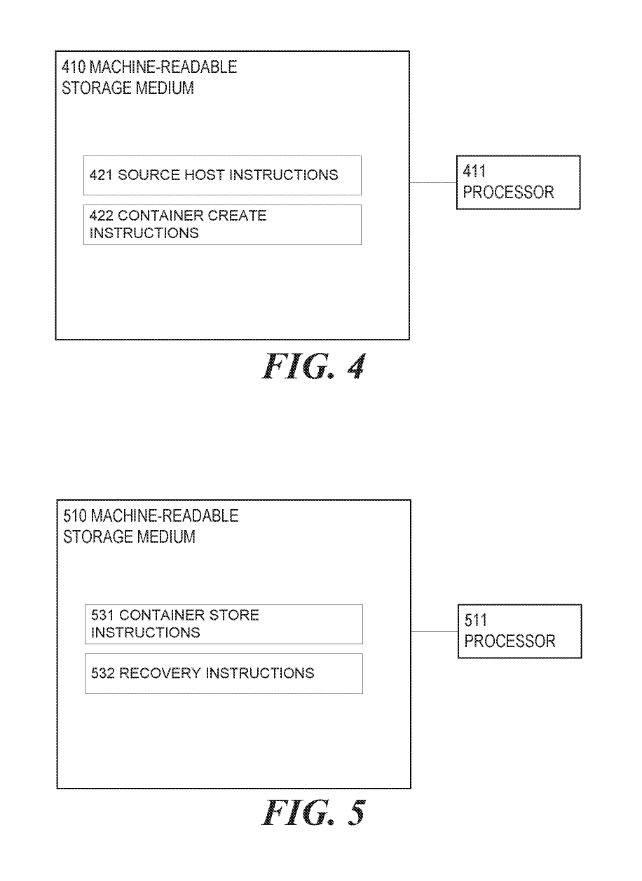

Source host 120 may comprise a source host engine 121, a container create engine 122, and/or other engines. Container host 130 may comprise a container store engine 131, a recovery engine 132, and/or other engines. The term “engine”, as used herein, refers to a combination of hardware and programming that performs a designated function. As is illustrated respect to FIGS. 4-5, the hardware of each engine, for example, may include one or both of a processor and a machine-readable storage medium, while the programming is instructions or code stored on the machine-readable storage medium and executable by the processor to perform the designated function.

Source host engine 121 may analyze a source host (e.g., source host 120A) to be backed up. Based on the analysis, source host engine 121 may determine a portion of the source host for which a container representation is to be created. A “container representation” may refer to a source host image that is captured at the time of backup, which will further discussed in detail with respect to container create engine 122.

In some implementations, source host engine 121 may employ different mechanisms for different source host types. This means that the analysis can be different depending on the type (e.g., file server, email server, virtual instance, etc.) of the source host to be backed up. In many cases, the source host is not a container instance. In one example, the source host can be a file server. In this example, source host engine 121 may identify a backup specification to determine which portion of the source host would be backed up. A file server may have multiple volumes (e.g., C:, E:, F:), but the backup specification may indicate that the volume F: is the one that is subject to a backup. In this case, a container representation would be created with that volume but not the other volumes. In another example, the source host can be a database server. In this example, source host engine 121 may analyze the database infrastructure and backup the information related to the database infrastructure including database configuration data, network configuration data, etc.

Container create engine 122 may create a container representation that comprises a source host image that is captured at the time of backup. This means that the container represents a snapshot of a “live” state of the source host at the time of backup. Thus, the container representation may capture a point-in-time state of: applications, their dependencies (e.g., code, runtime, and system tools and libraries), configuration data (e.g., database infrastructure configuration data, network configuration data, etc.), and/or any other data of the source host. In addition, because containerization technologies package all of the necessary data such as an application and its dependencies, and configuration data of a complete filesystem, a resulting container representation can run in any host environment (e.g., on premises, public cloud, private cloud, or bare metal). Container representations may be created by using any type of containerization technologies, including but not being limited to Docker, Rocket, LXD containerization, and Hyper-V containers.

In some implementations, a container representation may be a full backup of at least a portion of the source host or an incremental backup of at least a portion of the source host. Container create engine 122 may create a first container representation of at least a portion of the source host at a first point in time (e.g., 4PM on Day 1). Container create engine 122 may create a second container representation of at least a portion of the source host at a second point in time (e.g., 2AM on Day 4). The second container representation is considered to be an incremental backup if the second container representation comprises changes that have been made to the portion of the source host from the first point in time to the second point in time, but excludes any information backed up as part of the first container representation. On the other hand, the second container representation is considered to be a full backup if the second container representation comprises not only the changes that have been made to the portion of the source host from the first point in time to the second point in time but also includes any data contained in the first container representation.

Container create engine 122 may send the created container representation to container host 130 to be stored in a data storage.

Container store engine 131 may store the container representation from source host 120 in a data storage such as data storage 139. Although data storage 139 is depicted as a local data storage for container host 130, data storage 139 may be a remote data storage that is connected to container host 130 via network (e.g., network 50).

In some implementations, container store engine 131 may archive container representation files that are not frequently used to a secondary storage target, and, when needed, bring back a particular archived container representation file to container host 130 for it to be launched. In some implementations, an archived container representation may be launched from the secondary storage target by writing volume plugins.

Recovery engine 132 may enable data recovery by launching a container representation of source host 120 at container host 130. In one example, the container representation (or any portion thereof) may be copied to a target destination for recovery at the target destination. In another example, the container representation that includes an operating system (OS) can be instantiated on its own by running any applications backed up in the container representation from the container representation itself. In both of these examples, the recovery time can be significantly shorter than using non-containerization-based backup and recovery techniques.

Recovery engine 132 may launch a first container representation that was created at a first point in time and that captured a particular state of a software application that was running on source host 120 at the first point in time. Launching of the first container representation may comprise running the software application with that particular state of the software application that was running on source host 120 at the first point in time. In other words, the software application when launched would have the particular state as captured at the first point in time. Similarly, if there is a second container representation that was created a second point in time and that captured a particular state of the software application that was running on source host 120 at the second point in time, launching of the second container representation may comprise running the software application with that particular state of the software application that was running on the source host 120 at the second point in time.

In some implementations, a container representation may be launched and/or shut down in an instant, meaning that a user can access the data in the container very quickly without waiting for the backup data be fully recovered. In addition, an individual data item may be restored from the backup data in a container representation without having to recover the entire backup data. Recovery engine 132 may receive a user indication that a particular data item should be recovered from a container representation. In response to the user indication, recovery engine 132 may recover the particular data item without recovering the rest of the container representation other than the particular data item. For example, a single email may be recovered from a container representation of an email server without having to restoring the entire email backup data from the container representation.

In performing their respective functions, engines 121, 122, 131, and 132 may access data storage 129, data storage 139, and/or other suitable database(s). Data storages 129 and/or 139 may represent any memory accessible to system 100 that can be used to store and retrieve data. Data storage 129, 139, and/or other data storage may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. System 100 may access data storages 129 and/or 139 locally or remotely via network 50 or other networks.

Data storages 129 and/or 139 may include a database to organize and store data. The database may reside in a single or multiple physical device(s) and in a single or multiple physical location(s). The database may store a plurality of types of data and/or files and associated data or file description, administrative information, or any other data.

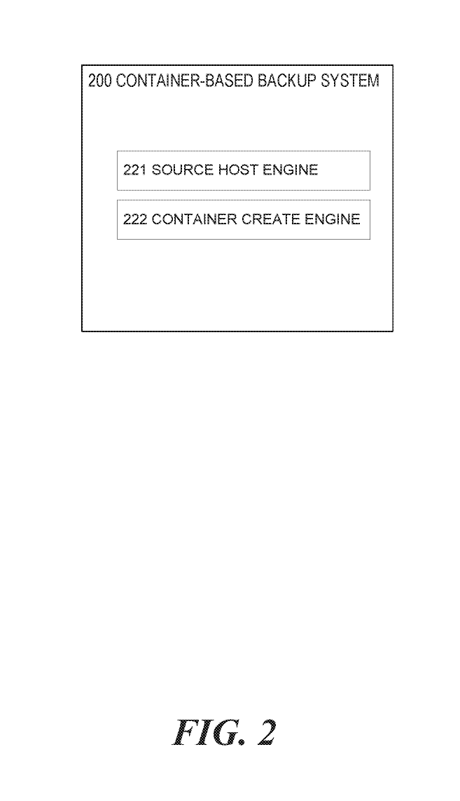

FIG. 2 is a block diagram depicting an example container-based backup system 200. Container-based backup system 200 may comprise a source host engine 221, a container create engine 222, and/or other engines. Engines 221-222 represent engines 121-122, respectively.

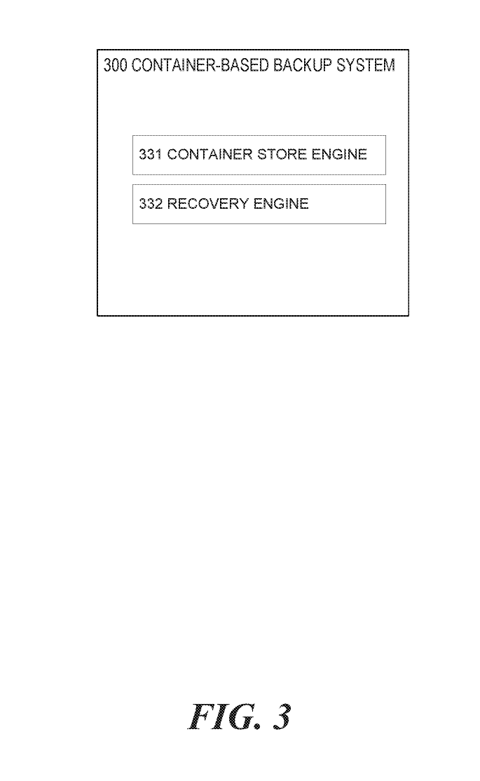

FIG. 3 is a block diagram depicting an example container-based backup system 300. Container-based backup system 300 may comprise a container store engine 331, a recovery engine 332, and/or other engines. Engines 331-332 represent engines 131-132, respectively.

FIG. 4 is a block diagram depicting an example machine-readable storage medium 410 comprising instructions executable by a processor for enabling a container-based backup.

In the foregoing discussion, engines 121-122 were described as combinations of hardware and programming. Engines 121-122 may be implemented in a number of fashions. Referring to FIG. 4, the programming may be processor executable instructions 421-422 stored on a machine-readable storage medium 410 and the hardware may include a processor 411 for executing those instructions. Thus, machine-readable storage medium 410 can be said to store program instructions or code that when executed by processor 411 implements container-based backup system 200 of FIG. 2.

In FIG. 4, the executable program instructions in machine-readable storage medium 410 are depicted as source host instructions 421 and container create instructions 422. Instructions 421-422 represent program instructions that, when executed, cause processor 411 to implement engines 121-122, respectively.

FIG. 5 is a block diagram depicting an example machine-readable storage medium 510 comprising instructions executable by a processor for enabling a container-based backup.

In the foregoing discussion, engines 131-132 were described as combinations of hardware and programming. Engines 131-132 may be implemented in a number of fashions. Referring to FIG. 5, the programming may be processor executable instructions 531-532 stored on a machine-readable storage medium 510 and the hardware may include a processor 511 for executing those instructions. Thus, machine-readable storage medium 510 can be said to store program instructions or code that when executed by processor 511 implements container-based backup system 300 of FIG. 3.

In FIG. 5, the executable program instructions in machine-readable storage medium 510 are depicted as container store instructions 531 and recovery instructions 532. Instructions 531-532 represent program instructions that, when executed, cause processor 511 to implement engines 131-132, respectively.

Machine-readable storage medium 410 (or machine-readable storage medium 510) may be any electronic, magnetic, optical, or other physical storage device that contains or stores executable instructions. In some implementations, machine-readable storage medium 410 (or machine-readable storage medium 510) may be a non-transitory storage medium, where the term “non-transitory” does not encompass transitory propagating signals. Machine-readable storage medium 410 (or machine-readable storage medium 510) may be implemented in a single device or distributed across devices. Likewise, processor 411 (or processor 511) may represent any number of processors capable of executing instructions stored by machine-readable storage medium 410 (or machine-readable storage medium 510). Processor 411 (or processor 511) may be integrated in a single device or distributed across devices. Further, machine-readable storage medium 410 (or machine-readable storage medium 510) may be fully or partially integrated in the same device as processor 411 (or processor 511), or it may be separate but accessible to that device and processor 411 (or processor 511).

In one example, the program instructions may be part of an installation package that when installed can be executed by processor 411 (or processor 511) to implement system 100. In this case, machine-readable storage medium 410 (or machine-readable storage medium 510) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 410 (or machine-readable storage medium 510) may include a hard disk, optical disk, tapes, solid state drives, RAM, ROM, EEPROM, or the like.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-422, and/or other instructions. As an alternative or in addition to retrieving and executing instructions, processor 411 may include at least one electronic circuit comprising a number of electronic components for performing the functionality of at least one of instructions 421-422, and/or other instructions.

Processor 511 may be at least one central processing unit (CPU), microprocessor, and/or other hardware device suitable for retrieval and execution of instructions stored in machine-readable storage medium 510. Processor 511 may fetch, decode, and execute program instructions 531-532, and/or other instructions. As an alternative or in addition to retrieving and executing instructions, processor 511 may include at least one electronic circuit comprising a number of electronic components for performing the functionality of at least one of instructions 531-532, and/or other instructions.

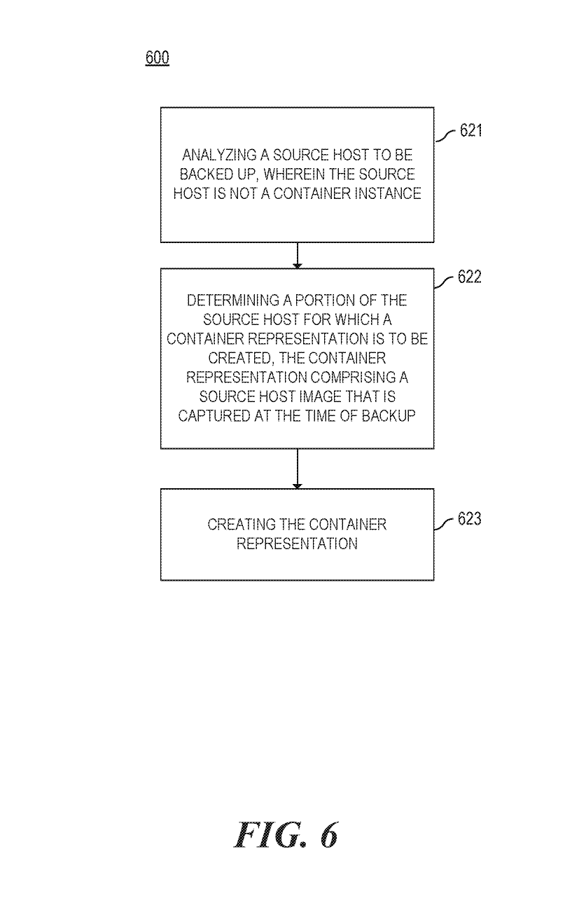

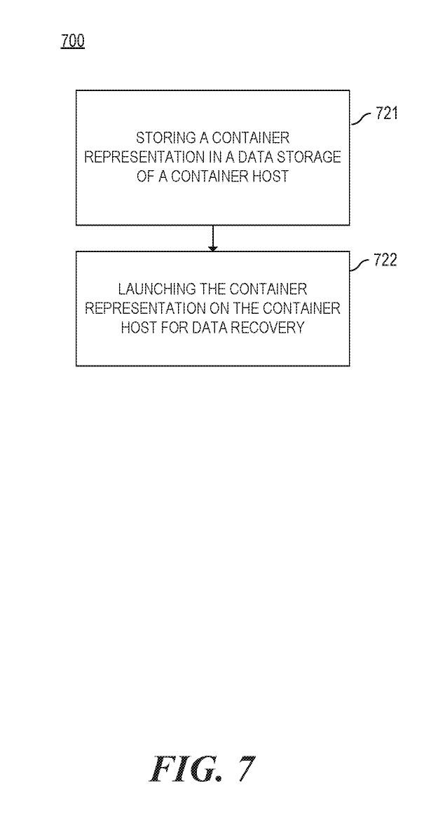

FIG. 6 is a flow diagram depicting an example method 600 for enabling a container-based backup. The various processing blocks and/or data flows depicted in FIG. 6 (and in the other drawing figures such as FIG. 7) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 600 as illustrated (and described in greater detail below) is meant to be an example and, as such, should not be viewed as limiting. Method 600 may be implemented in the form of executable instructions stored on a machine-readable storage medium, such as storage medium 410 and/or 510, and/or in the form of electronic circuitry.

In block 621, method 600 may include analyzing a source host to be backed up, wherein the source host is not a container instance. Referring back to FIG. 1, source host engine 121 may be responsible for implementing block 621.

In block 622, method 600 may include determining a portion of the source host for which a container representation is to be created, the container representation comprising a source host image that is captured at the time of backup. Referring back to FIG. 1, source host engine 121 may be responsible for implementing block 622.

In block 623, method 600 may include creating the container representation. Referring back to FIG. 1, container create engine 122 may be responsible for implementing block 623.

FIG. 7 is a flow diagram depicting an example method 700 for enabling a container-based backup. Method 700 as illustrated (and described in greater detail below) is meant be an example and, as such, should not be viewed as limiting. Method 700 may be implemented in the form of executable instructions stored on a machine-readable storage medium, such as storage medium 410 and/or 510, and/or in the form of electronic circuitry.

In block 721, method 700 may include storing a container representation in a data storage of a container host. Referring back to FIG. 1, container store engine 131 may be responsible for implementing block 721.

In block 722, method 700 may include launching the container representation on the container host for data recovery. Referring back to FIG. 1, recovery engine 132 may be responsible for implementing block 722.

The foregoing disclosure describes a number of example implementations for container-based backups. The disclosed examples may include systems, devices, computer-readable storage media, and methods for container-based backups. For purposes of explanation, certain examples are described with reference to the components illustrated in FIGS. 1-5. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 6-7 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for enabling a container-based backup, the method comprising:
analyzing a source host to be backed up, wherein the source host is not a container instance;
determining a portion of the source host for which a container representation is to be created, the container representation comprising a source host image that is captured at the time of backup; and
creating the container representation.

2. The method of claim 1, comprising:
creating the container representation using a containerization technology.

3. The method of claim 1, wherein analyzing the source host to be backed up comprising:
identifying a backup specification to determine the portion of the source host for which the container representation is to be created.

4. The method of claim 3, wherein the source host comprises a filesystem server, comprising:
determining, based on the backup specification, a particular volume of the file system server for which the container representation is to be created, wherein the container representation comprises a backup of the particular volume.

5. The method of claim 3, wherein the source host comprises a database server, comprising:
determining, based on the backup specification, a particular database infrastructure of the database server for which the container representation is to be created.

6. The method of claim 5, wherein the container representation comprises a backup of configuration data of the particular database infrastructure.

7. The method of claim 1, wherein the source host comprises a virtual machine instance.

8. The method of claim 1, wherein the container representation comprises an incremental backup of the portion of the source host.

9. The method of claim 8, comprising:
creating a first container representation of the portion of the source host at a first point in time; and
creating a second container representation of the portion of the source host at a second point in time, wherein the second container representation comprises changes that have been made to the portion of the source host from the first point in time to the second point in time.

10. The method of claim 1, wherein the container representation is stored in a data storage of a container host.

11. A non-transitory machine-readable storage medium comprising instructions executable by a processor of a computing device for enabling a container-based backup, the machine-readable storage medium comprising:
instructions to analyze a source host to be backed up, wherein the source host is not a container instance;
instructions to identify a backup specification that specifies a type of the source host and a portion of the source host for which a container representation is to be created, the container representation comprising a source host image that is captured at the time of backup; and
instructions to send the container representation to a container host to be stored in a data storage.

12. The non-transitory machine-readable storage medium of claim 11, wherein the type of source host comprises one of a filesystem server, a database server, an email server, a web server, an application host server, a SharePoint farm, and a virtual machine instance.

13. The non-transitory machine-readable storage medium of claim 11, wherein the container representation comprises a full backup, comprising:
creating a first container representation of the portion of the source host at a first point in time; and
creating a second container representation of the portion of the source host at a second point in time, wherein the second container representation comprises data contained in the first container representation, and a backup of changes that have been made to the portion of the source host from the first point in time to the second point in time.

14. The non-transitory machine-readable storage medium of claim 11, wherein the container representation comprises an incremental backup, comprising:
creating a first container representation of the portion of the source host at a first point in time; and
creating a second container representation of the portion of the source host at a second point in time, wherein the second container representation comprises a backup of changes that have been made to the portion of the source host from the first point in time to the second point in time.

15. The non-transitory machine-readable storage medium of claim 11, wherein the container representation is launched on the container host for data recovery.

16. A system for enabling a container-based backup comprising:
a source host comprising a first non-transitory machine readable storage medium comprising instructions executable by a first processor of the source host, the first machine-readable storage medium comprising:
instructions to analyze a source host to be backed up, wherein the source host is not a container instance;
instructions to determine a portion of the source host for which a container representation is to be created;
instructions to create a first container representation of the portion of the source host at a first point in time, wherein the first container representation captures a first point-in-time state of a software application that runs on the source host; and
instructions to create a second container representation of the portion of the source host at a second point in time, wherein the second container representation captures a second point-in-time state of the software application.

17. The system of claim 16, comprising:
a container host comprising a second non-transitory machine readable storage medium comprising instructions executable by a second processor of the container host, the second machine-readable storage medium comprising:
instructions to store the first container representation in a data storage of the container host; and
instructions to launch the first container representation on the container host for data recovery.

18. The system of claim 17, the instructions to launch the first container representation on the container host comprise instructions to run the software application with the first point-in-time state from the first container representation.

19. The system of claim 17, the second machine-readable storage medium comprising:
instructions to receive a user indication that a particular data item should be recovered from the first container representation; and
in response to the user indication, instructions to recover the particular data item without recovering the rest of the first container representation other than the particular data item.

20. The system of claim 17, wherein the first container representation comprises an operating system (OS) that enables executing the software application when the first container representation is launched on the container host for data recovery.
